(19) United States
(12) Patent Application Publication
(10) Pub. No.: US 2015/0134969 A1
(43) Pub. Date: May 14, 2015

(54) DEVICE AND METHOD FOR PROVIDING SECUIRTY ASSISTANT SERVICE

(71) Applicant: Electronics and Telecommunications Research Institute, Daejeon (KR)

(72) Inventors: Soo-Hyung KIM, Daejeon (KR); Young-Seob Cho, Daejeon (KR); Jong-Hyouk Noh, Daejeon (KR); Sang-Rae Cho, Daejeon (KR); Dae-Seon Choi, Daejeon (KR); Seung-Hyun Kim, Daejeon (KR); Seok-Hyun Kim, Daejeon (KR); Jin-Man Cho, Daejeon (KR); Seung-Hun Jin, Daejeon (KR); Hyun-Sook Cho, Daejeon (KR)

(73) Assignee: Electronics and Telecommunications Research Institute, Daejeon (KR)

(21) Appl. No.: 14/243,081

(22) Filed: Apr. 2, 2014

(30) Foreign Application Priority Data
Nov. 13, 2013 (KR) 10-2013-0137901

(51) Int. Cl. H04L 9/32

(52) U.S. Cl. CPC H04L 9/3247; H04L 2209/72
USPC 713/176

(57) ABSTRACT

There are provided a method and device for providing a security assistant service. In an embodiment of the invention, there is provided a device for providing a security assistant service in which a first terminal and a second terminal are included. The device includes the first terminal configured to generate information for requesting verification of an original plaintext to be signed (here, the information for requesting verification of the original plaintext to be signed refers to the original plaintext to be signed or a hash value of the original plaintext to be signed) and transmit an encrypted value in which the information for requesting verification of the original plaintext to be signed is encrypted and the original plaintext to be signed to the second terminal, and the second terminal configured to receive the original plaintext to be signed and the encrypted value, decrypt the information for requesting verification of the original plaintext to be signed by decrypting the encrypted value, display the original plaintext to be signed when the original plaintext to be signed or a hash value of the original plaintext to be signed matches the decrypted information for requesting verification of the original plaintext to be signed, receive a verification signal from a user, generate an original verification message (here, the original verification message refers to information indicating that the original plaintext to be signed is verified by the user and the information can be proved using a key held by the second terminal and verified using the key held by the first terminal) and transmit the original verification message to the first terminal.

### CROSS-REFERENCE TO RELATED APPLICATION

This application claims priority to and the benefit of Korean Patent Application No. 10-2013-0137901, filed on Nov. 13, 2013, the disclosure of which is incorporated herein by reference in its entirety.

### BACKGROUND

1. Field of the Invention

The present invention relates to mobile security, and more particularly, to a device and method for providing a security function that is required to utilize a service of a first terminal through a second terminal.

2. Discussion of Related Art

Recently, due to the development of mobile technology, a service environment in which various services can be provided for users at any time and any place through mobile terminals has emerged. However, in such a service environment, users may be exposed to cyber-attacks such as personal information leakage, phishing, and pharming.

In the related art, security services such as malicious code search, anti-spam, and hacking detection have been provided. In addition, security services using a secure element such as a USIM card, that is, using hardware capable of providing a security service, have been provided.

For example, a digital signature service in which a digital signature key is registered in the USIM card or is directly generated in the USIM card and digital signing using a corresponding key is performed inside the USIM card so that the digital signature key is not exposed outside of the USIM card has recently been commercialized. In such a technique, when a mobile terminal of the user is hacked, the digital signature key in the USIM card may be safely managed. However, when the mobile terminal is controlled by a hacker, although the digital signature key is not leaked, digital signing data may be modified by the hacker.

Authentication information of a mobile service used by the user may be leaked when the information is input through a mobile terminal interface or is stored in the mobile terminal. The authentication information that is directly input by the user may be obtained by hooking technology, a phishing app, or the like, and the authentication information stored and used in the mobile terminal may be easily obtained.

In addition, content that is provided from a web server to the user may be exposed to the hacker in the mobile terminal. The content provided from the server may include important information that should not be exposed. Information that is critical when other content provided from the server is combined therewith, for example, a service temporary password, user identification information, and an authentication code, may be exposed to the hacker.

Patent literature No. 1: Korean Laid-open Patent Application No. 10-2007-0088132

### SUMMARY OF THE INVENTION

The present invention provides a device and method for providing a security assistant service in which a second terminal such as a smart watch or smart glasses can enhance a security function of a first terminal such as a smartphone or a tablet.

The present invention also provides a device and method for providing a security assistant service that can prevent digital signing data from being maliciously changed by the first terminal in advance, prevent the authentication information from being leaked in the first terminal, and check a risk of confidential information leakage in the second terminal in advance.

The present invention also provides a device and method for providing a security assistant service that can securely use the service even when the first terminal is hacked and prevent the terminal from being abused using only information obtained in the second terminal even when the second terminal is hacked.

According to an aspect of the invention, there is provided a device for providing a security assistant service in which a first terminal and a second terminal are included. The device includes the first terminal configured to generate information for requesting verification of an original plaintext to be signed (here, the information for requesting verification of the original plaintext to be signed refers to the original plaintext to be signed or a hash value of the original plaintext to be signed) and transmit an encrypted value in which the information for requesting verification of the original plaintext to be signed is encrypted and the original plaintext to be signed to the second terminal, and the second terminal configured to receive the original plaintext to be signed and the encrypted value, decrypt the information for requesting verification of the original plaintext to be signed by decrypting the encrypted value, display the original plaintext to be signed when the original plaintext to be signed or a hash value of the original plaintext to be signed matches the decrypted information for requesting verification of the original plaintext to be signed, receive a verification signal from a user, generate an original verification message (here, the original verification message refers to information indicating that the original plaintext to be signed is verified by the user and the information can be proved using a key held by the second terminal and verified using the key held by the first terminal) and transmit the original verification message to the first terminal.

A key in which the information for requesting verification of the original plaintext to be signed is encrypted by the first terminal and a key for decrypting the encrypted value by the second terminal may be the same key.

The first terminal may be any of a smartphone and a tablet. The second terminal may be any of a smart watch and smart glasses.

The first terminal may include an application unit configured to generate the information for requesting verification of the original plaintext to be signed, a secure element unit configured to receive the information for requesting verification of the original plaintext to be signed from the application unit, encrypt and transmit the information for requesting verification of the original plaintext to be signed, receive the original verification message, generate original verification and validation information or a digital signing value for verified request information (here, the original verification and validation information is able to verify that an original corresponding to the digital signature value is verified by the user and is not changed using a key held by a server connected to the application unit when the server connected to the application unit for which a digital signature is requested receives the original verification and validation information in addition to a digital signature value), and provide the information to the application unit, a security assistant host unit configured to receive the original plaintext to be signed from the application unit, receive the encrypted value from the secure element unit, and request verification of the original plaintext to be signed from the second terminal, and a first terminal communication module configured to connect the first terminal and the second terminal via a communication network.

The security assistant host unit may receive a registration request of the application unit from the application unit, generate an ID of the application unit, and request registration of the ID from the second terminal.

The ID may include at least one of a unique identification number of the application unit and an international mobile equipment identity (IMEI) of the first terminal.

After an authentication information request of the application unit is received from the application unit and is transmitted to the second terminal, when the second terminal generates authentication information of the application unit and transmits the information to the first terminal, the security assistant host unit may provide the authentication information to the application unit.

The second terminal may include a security assistant service unit configured to receive the original plaintext to be signed and the encrypted value from the first terminal, decrypt the information for requesting verification of the original plaintext to be signed (here, the information for requesting verification of the original plaintext to be signed refers to the original plaintext to be signed or a hash value of the original plaintext to be signed) by decrypting the encrypted value, determine whether the original plaintext to be signed or a hash value of the original plaintext to be signed matches a decrypted value, receive a verification signal from the user, and generate the original verification message (here, the original verification message refers to information indicating that the original plaintext to be signed is verified by the user and the information can be proved using a key held by the second terminal and verified using the key held by the first terminal), a display unit configured to display the original plaintext to be signed when the original plaintext to be signed or the hash value of the original plaintext to be signed matches the decrypted value, a user interface unit configured to verify the original plaintext to be signed displayed on the display unit by the user, and a second terminal communication module configured to connect the first terminal and the second terminal via a communication network.

According to another aspect of the invention, there is provided a method of providing a security assistant service. The method includes generating, by a first terminal, an original plaintext to be signed and a hash value of the original plaintext to be signed, generating, by the first terminal, an encrypted value by encrypting the original plaintext to be signed or the hash value of the original plaintext to be signed using a key, receiving, by the second terminal, the encrypted value and the original plaintext to be signed from the first terminal, an generating a decrypted value by decrypting the encrypted value using the key, determining whether the decrypted value matches the original plaintext to be signed or the hash value of the original plaintext to be signed, displaying the original plaintext to be signed when the decrypted value matches the original plaintext to be signed or the hash value of the original plaintext to be signed, receiving a signal for verifying that the original plaintext to be signed is not changed from the user and generating the original verification message, and transmitting, by the second terminal, the original verification message to the first terminal.

The first terminal may be any of a smartphone and a tablet. The second terminal may be any of a smart watch and smart glasses.

According to still another aspect of the invention, there is provided a method of providing a security assistant service. The method includes generating, by a first terminal, an original plaintext to be signed, and transmitting the signature to a second terminal, displaying the original plaintext to be signed on the second terminal, receiving a signal for verifying that the original plaintext to be signed is not changed from the user, and generating the original verification message including the original plaintext to be signed or a hash value of the original plaintext to be signed, connecting the second terminal to the first terminal via a short-distance communication network, transmitting, by the second terminal, the original verification message to the first terminal, receiving, by the first terminal, the original verification message, verifying the original verification message, and decrypting the original plaintext to be signed included in the original verification message or the hash value of the original plaintext to be signed, and digitally signing the decrypted value or generating original verification and validation information (here, the original verification and validation information is able to verify that an original corresponding to the digital signature value is verified by the user and is not changed using a key held by a server connected to the application unit when the server connected to the application unit for which a digital signature is requested receives the original verification and validation information in addition to a digital signature value).

According to yet another aspect of the invention, there is provided a method of providing a security assistant service. The method includes generating and transmitting an ID of an application unit of a first terminal, receiving, by a second terminal, the ID, and generating authentication information of the application unit based on the ID, and storing, by the second terminal, the authentication information, and transmitting the authentication information to the first terminal.

The method may further include requesting, by the first terminal, an inquiry of the authentication information from the second terminal, receiving, by the second terminal, the request, and making an inquiry of the authentication information, displaying, by the second terminal, the authentication information, and receiving a verification signal from the user, and transmitting, by the second terminal, an inquiry result including the authentication information to the first terminal.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block diagram illustrating configurations of a first terminal and a second terminal which are included in a device for providing a security assistant service according to an embodiment of the invention;

FIG. 2 is a sequence diagram illustrating a method of registering a key according to an embodiment of the invention;

FIG. 3 is a sequence diagram illustrating a method of providing a digital signature assistant service according to an embodiment of the invention;

FIG. 4 is a sequence diagram illustrating a method of providing a digital signature assistant service according to an embodiment of the invention;

FIG. 5 is a sequence diagram illustrating a method of providing a digital signature assistant service according to an embodiment of the invention;

FIG. 6 is a sequence diagram illustrating a method of registering an application according to an embodiment of the invention;

FIG. 7 is a sequence diagram illustrating a method of requesting authentication information of an application according to an embodiment of the invention;

FIG. 8 is a sequence diagram illustrating a method of providing a confidential information service according to an embodiment of the invention; and

FIG. 9 is a sequence diagram illustrating a method of providing a confidential information service according to an embodiment of the invention.

### DETAILED DESCRIPTION OF EXEMPLARY EMBODIMENTS

While the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims. Although the terms used herein are selected from among general terms that are currently and widely used in consideration of functions in the present invention, these may be changed according to intentions or customs of those skilled in the art or the advent of new technology. In addition, in certain cases, some terms may be arbitrarily selected by the applicants. In such cases, meanings thereof will be described in a corresponding description of the invention. Therefore, the meanings of terms used herein should be interpreted based on substantial meanings of the terms and content of this entire specification, rather than simply the terms themselves.

Hereinafter, embodiments of the invention will be described in detail with reference to the accompanying drawings.

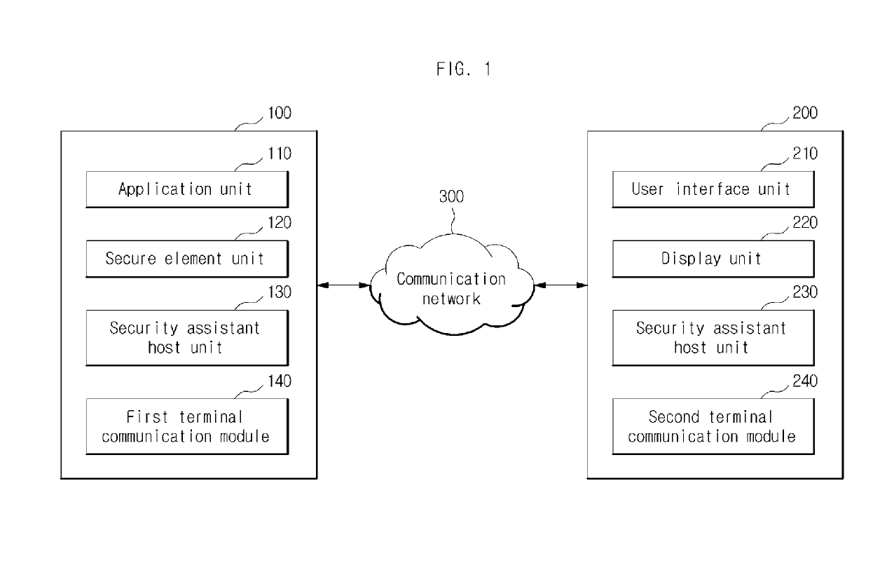

FIG. 1 is a block diagram illustrating configurations of a first terminal 100 and a second terminal 200 which are included in a device for providing a security assistant service according to an embodiment of the invention.

As illustrated in FIG. 1, the device for providing a security assistant service according to the embodiment of the invention may include the first terminal 100 and the second terminal 200.

The first terminal 100 may generate information for requesting verification of an original plaintext to be signed, and transmit an encrypted value in which the information for requesting verification of the original plaintext to be signed is encrypted and the original plaintext to be signed (M) to the second terminal 200. Here, the information for requesting verification of the original plaintext to be signed may include the original plaintext to be signed (M) or a hash value (H(M)) (hereinafter referred to as “H”) of the original plaintext to be signed (M). In order to prevent forgery or alteration of an electronic document, the digital signature may include a signature of an encrypted information form which is inserted into a corresponding document so as to verify a creator. The digital signature may be included in a structure of data for which the digital signature is required or outside of a structure of data for which the digital signature is required. The data for which the digital signature is required may include user authentication information and user payment and approval information, but a type of the data for which the digital signature is required is not limited thereto.

The second terminal 200 may receive the original plaintext to be signed (M) and an encrypted value (E_{K}(H)), decrypt the encrypted value (E_{K}(H)), and decrypt the information for requesting verification of the original plaintext to be signed. In addition, when the original plaintext to be signed (M) or the hash value (H) of the original plaintext to be signed (M) matches the decrypted information for requesting verification of the original plaintext to be signed, the original plaintext to be signed (M) may be displayed, a verification signal may be received from a user, and an original verification message may be generated. In addition, the original verification message may be transmitted to the first terminal 100. Here, the original verification message may include information indicating that the original plaintext to be signed (M) is verified by the user and the information can be proved using a key held by the second terminal 200 and verified using a key held by the first terminal 100.

In the device for providing a security assistant service according to the embodiment of the invention, it is possible to prevent digital signing data from being maliciously changed by the first terminal 100 in advance, and prevent authentication information leakage in the first terminal 100.

The first terminal 100 may be any of a portable terminal, a mobile terminal, a telematics terminal, a notebook computer, a digital broadcasting terminal, a personal digital assistant (PDA), a Wibro terminal, an Internet protocol television (IPTV) terminal, an audio video navigation (AVN) terminal, a portable multimedia player (PMP), a navigation terminal (vehicle navigation device), a smartphone, and a tablet, and may include any terminal that requests security of data for which the digital signature is required and the digital signature via wired and/or wireless communication.

The second terminal 200 may include the same terminal as the first terminal 100. For example, the second terminal 200 may include the smartphone, a smart watch, or smart glasses. The second terminal 200 is not limited to a specific electronic device but includes any terminal which can receive a security request of the digital signature and the data for which the digital signature is required from the first terminal 100 and can receive a signal for verifying with the user that the data for which the digital signature is required is not changed.

The first terminal 100 may include an application unit 110, a secure element unit 120, a security assistant host unit 130, and a first terminal communication module 140.

The application unit 110 may generate the information for requesting verification of the original plaintext to be signed. Here, the information for requesting verification of the original plaintext to be signed may include the original plaintext to be signed (M) or the hash value (H(M)) (hereinafter referred to as “H”) of the original plaintext to be signed (M). In the embodiment, the first terminal 100 generates the information for requesting verification of the original plaintext to be signed and may transmit the encrypted value (E_{K}(H)) in which the information for requesting verification of the original plaintext to be signed is encrypted and the original plaintext to be signed (M) to the second terminal 200. In the embodiment, the application unit 110 may include a program that is executed in the first terminal 100. Examples of the program executed in the first terminal 100 may include a program for broadcasting Internet shopping, a program for providing games, and a program for payment and approval, but functions and operations of the program are not specifically limited. In order to perform operations, the application unit 110 may include the digital signature. In addition, the application unit 110 may include a unique identification number.

The hash value (H) of the original plaintext to be signed (M) may include a code derived from the result of a hash function. Here, the hash function may output a value having a constant length independently from a length of an input value. The hash function may output different hash results when input values are different. When content of the data for which the digital signature is required is modified, deleted, or added, the input value of the hash function is changed and thus the output value may also be changed. Therefore, it is possible to check whether file alteration is performed by comparing a hash value of an original file and a hash value of a downloaded file. In the embodiment, the hash function may include MD5 or SHA.

The secure element unit 120 may receive the information for requesting verification of the original plaintext to be signed from the application unit 110, and encrypt and transmit the information for requesting verification of the original plaintext to be signed. The secure element unit 120 may receive the original verification message, generate original verification and validation information or a digital signing value for verified request information, and provide the result to the application unit 110. Here, the term “original verification and validation information” refers to information indicating that a server connected to an application unit which requests the digital signature receives the original verification and validation information in addition to a digital signature value, the original corresponding to the digital signature value is verified by the user, and no fabrication of the original is verified using a key held by the server connected to the application unit 110. In addition, the secure element unit 120 of the first terminal 100 may generate a key required for a digital signature assistant service using short-distance wireless communication with a security assistant service unit 230 of the second terminal 200. Here, the short-distance wireless communication may include NFC communication. The secure element unit 120 is connected to the security assistant service unit 230 through the NFC communication, and may register a key required for encryption and decryption through the NFC communication.

The security assistant host unit 130 may receive the original plaintext to be signed (M) and the encrypted value (E_{K}(H)) from the application unit 110 and may also request verification of the original plaintext to be signed from the second terminal 200. In addition, when it is difficult to generate the key required for the digital signature assistant service using the short-distance wireless communication, the security assistant host unit 130 may generate a key required for the digital signature and unique identification information of the application unit 110. In the embodiment, the security assistant host unit 130 may receive a registration request of the application unit 110 from the application unit 110, generate an ID of the application unit 110, and request registration of the ID from the second terminal 200. Here, the ID may include at least one of the unique identification number of the application unit 110 and an international mobile equipment identity (IMEI) of the first terminal 100.

After the security assistant host unit 130 receives an authentication information request of the application unit 110 from the application unit 110 and transmits the request to the second terminal 200, when the second terminal 200 generates authentication information of the application unit 110 and transmits the authentication information to the first terminal 100, the authentication information may be provided to the application unit 110.

The first terminal communication module 140 may connect the first terminal 100 and the second terminal 200 via a communication network. Here, a communication network 300 may be any of Bluetooth, Zigbee, near field communication (NFC), Wi-Fi, Wireless Broadband (Wibro), Worldwide Interoperability for Microwave Access (WiMAX), High Speed Downlink Packet Access (HSDPA), IEEE 802.16, Long Term Evolution (LTE), and a wireless mobile broadband service (WMBS).

The second terminal 200 may include a user interface unit 210, a display unit 220, the security assistant service unit 230, and a second terminal communication module 240.

The security assistant service unit 230 may receive the original plaintext to be signed (M) and the encrypted value (E_{K}(H)) from the first terminal 100, decrypt the encrypted value (E_{K}(H)), and decrypt the information for requesting verification of the original plaintext to be signed. In addition, it may be determined whether the original plaintext to be signed (M) or the hash value (H) of the original plaintext to be signed (M) matches a decrypted value (D_{K}(E_{K}(H))), the verification signal may be received from the user, and the original verification message may be generated. In another embodiment, the security assistant service unit 230 may provide a process of verifying whether the original plaintext to be signed (M) received from the first terminal 100 is data created by the user, and whether the data has been changed, forged, or altered since being created.

When the original plaintext to be signed (M) or the hash value (H) of the original plaintext to be signed (M) matches the decrypted value (D_{K}(E_{K}(H))), the display unit 220 may display the original plaintext to be signed (M). For example, the display unit 220 may control a display device of the second terminal 200 and display the original plaintext to be signed (M). The display device may include a liquid crystal display (LCD) device of the second terminal 200. For example, the display device may be any of an LCD, a single-chip digital light processing (DLP) projector, a three-chip DLP projector, a cathode ray tube (CRT), a plasma display panel, a liquid crystal on silicon (LCS), holographic images on a transparent screen, an organic light emitting diode (OLED), and an LED electronic display.

The user interface unit 210 may provide a process for the user to verify the original plaintext to be signed (M) displayed on the display unit 220. The user interface unit 210 may include, for example, a form of a keyboard or a virtual keyboard, but a method of delivering information between the user and the second terminal 200 is not specifically limited thereto. In addition, the user interface unit 210 may include a touch screen implemented in the second terminal 200.

The second terminal communication module 240 may connect the first terminal 100 and the second terminal 200 via the communication network. The second terminal communication module 240 may receive the digital signature, the data for which the digital signature is required, and a security request from the first terminal 100. In addition, the second terminal communication module 240 may receive the key required for the digital signature, the data for which the digital signature is required, the digital signature generated by the security assistant host unit 130, and the unique identification information of the application unit 110. The second terminal communication module 240 may be connected like the first terminal communication module 140 via wired and/or wireless communication. Moreover, the second terminal communication module 240 may provide short-distance communication. Examples of the short-distance communication may include Bluetooth, radio frequency identification (RFID), Infrared Data Association (IrDA), ultra wideband (UWB), ZigBee, and NFC.

A key in which the information for requesting verification of the original plaintext to be signed of the first terminal 100 and the second terminal 200 is encrypted and a key for the second terminal to decrypt the encrypted value may be the same. That is, when the second terminal 200 receives and displays information transmitted from the first terminal 100, information transmitted from the first terminal 100, transmitting or receiving information may be encrypted and transmitted. In order to decrypt the encrypted information, the first terminal 100 and the second terminal 200 may store the same encryption key. An operation of storing the encryption key may be performed in advance before the digital signature and the data for which the digital signature is required are transmitted. Here, as the same key for encryption and decryption, a symmetric key such as Data Encryption Standard (DES), Triple DES (3DES), and Advanced Encryption Standard (AES) may be used. In addition, the Rivest, Shamir, Adleman (RSA) algorithm or ElGamal algorithm may be used, but the encryption key is not limited thereto.

The original plaintext to be signed (M) according to the embodiment of the invention may include user authentication information or user payment and approval information. The second terminal 200 stores the authentication information. When the first terminal 100 requests the authentication information from the second terminal 200, the second terminal 200 verifies unique identification information of an application of the first terminal 100, and then may provide the authentication information to the first terminal 100. Here, after the unique identification information of the application unit 110 of the first terminal 100 is verified, when a forged or altered application unit 110 requests the user authentication information or the user payment and approval information, there may be no response to the request. In another embodiment, when an unauthorized application unit 110 requests user information, a message refusing the request may be transmitted. When the unique identification information of the application unit 110 is verified, it is possible to prevent hacking through the forged or altered application unit 110. Here, the unique identification information may be generated using any of a hash value for preventing forgery and alteration of the application unit 110 and the IMEI of the first terminal 100 or a combination thereof.

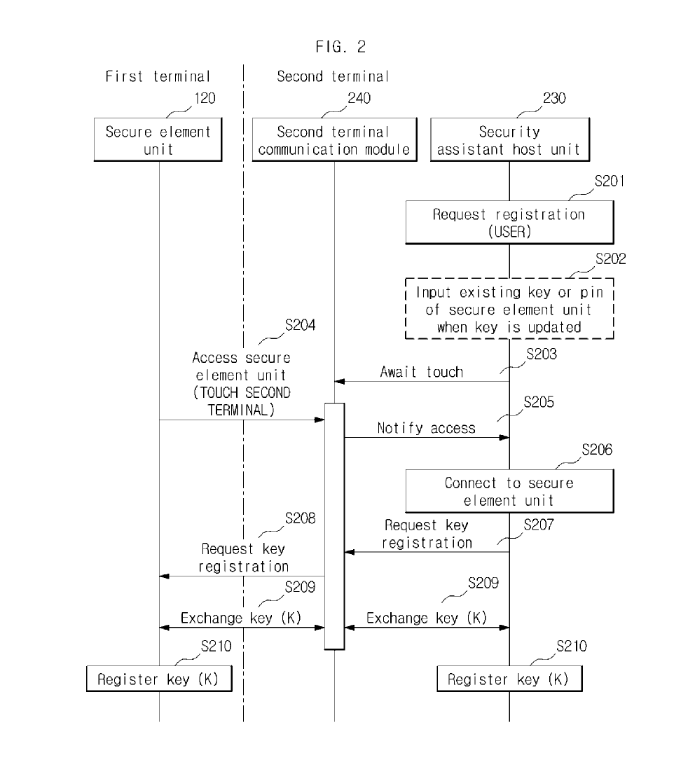

FIG. 2 is a sequence diagram illustrating a method of registering a key according to an embodiment of the invention.

As illustrated in FIG. 2, in S201, the security assistant service unit 230 may receive a registration request from the user. In this case, the registration request may be received through the user interface unit 210 of the second terminal 200.

When the key is updated in S202, an operation of inputting an existing key or inputting a password of the secure element unit 120 may be further included.

In S203, access of the first terminal 100 through a communication module of the second terminal 200 is awaited. Here, the communication module of the second terminal 200 may include a short-distance communication module and may provide the short-distance communication with the secure element unit 120 of the first terminal 100 through an NFC module.

When the secure element unit 120 of the first terminal 100 accesses the communication module of the second terminal 200 in S204, it is possible to provide a notification that the secure element unit 120 of the first terminal 100 has performed access in S205.

In S206, the security assistant service unit 230 of the second terminal 200 may be connected to the secure element unit 120 of the first terminal 100 through the short-distance communication.

In S207 and S208, when a key registration request is transmitted, the key is exchanged in S209. In S210, the secure element unit 120 of the first terminal 100 and the security assistant service unit 230 of the second terminal 200 may register the same key.

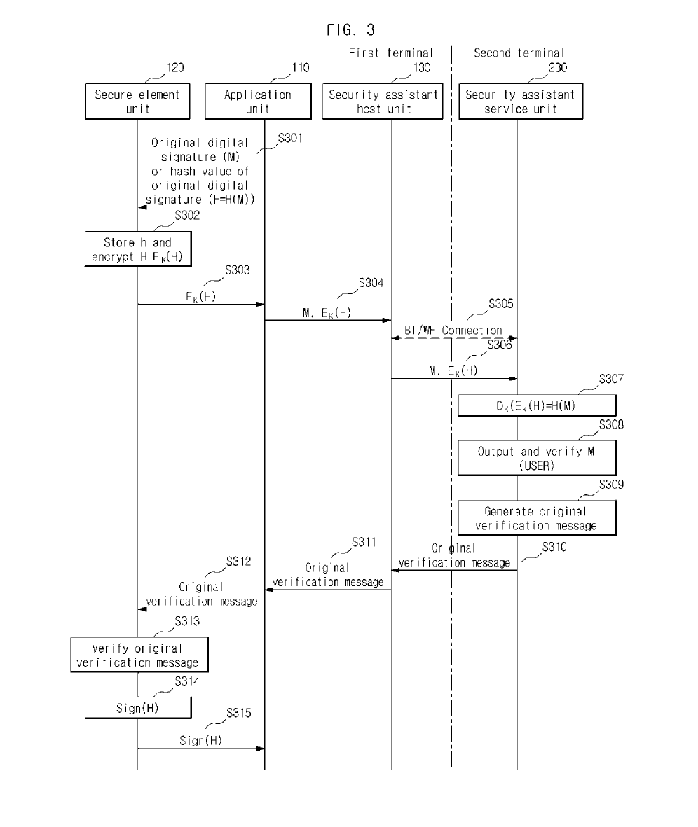

FIG. 3 is a sequence diagram illustrating a method of providing a digital signature assistant service according to an embodiment of the invention.

The method of providing a digital signature assistant service according to the embodiment of the invention may include, generating, by the first terminal 100, the original plaintext to be signed (M) and the hash value (H) of the original plaintext to be signed (M), generating, by the first terminal 100, the encrypted value ((E_{K}(H))) by encrypting the original plaintext to be signed (M) or the hash value (H) of the original plaintext to be signed (M) using the key, receiving, by the second terminal 200, the encrypted value ((E_{K}(H))) and the original plaintext to be signed (M) from the first terminal 100 and generating the decrypted value (D_{K}(E_{K}(H))) by decrypting the encrypted value ((E_{K}(H))) using the key, determining whether the decrypted value (D_{K}(E_{K}(H))) matches the original plaintext to be signed (M) or the hash value (H) of the original plaintext to be signed (M), displaying the original plaintext to be signed (M) when the decrypted value (D_{K}(E_{K}(H))) matches the original plaintext to be signed (M) or the hash value (H) of the original plaintext to be signed (M), generating the original verification message by receiving a signal for verifying with the user that the original plaintext to be signed is not changed, and transmitting, by the second terminal 200, the original verification message to the first terminal 100.

As illustrated in FIG. 3, in S301, the application unit 110 may transmit the original plaintext to be signed (M) or the hash value (H) of the original plaintext to be signed (M) to the secure element unit 120.

In S302, the secure element unit 120 stores the hash value (H) of the original plaintext to be signed (M) and may encrypt the hash value (H) of the original plaintext to be signed (M) using the key in S210.

In S303, the secure element unit 120 may transmit the hash value (E_{K}(H)) of the encrypted original plaintext to be signed to the application unit 110.

In S304, the application unit 110 may transmit the hash value (E_{K}(H)) of the encrypted original plaintext to be signed (M) and the original plaintext to be signed (M) to the security assistant host unit 130.

In S305, the first terminal communication module 140 and the second terminal communication module 240 may be connected.

In S306, the security assistant host unit 130 may transmit the hash value (E_{K}(H)) of the encrypted original plaintext to be signed and the original plaintext to be signed (M) to the security assistant service unit 230.

In S307, it may be determined whether the decrypted value (D_{K}(E_{K}(H))) of the hash value (H) of the encrypted original plaintext to be signed (M) matches the hash value of the second terminal 200.

In S308, the original plaintext to be signed (M) is displayed through the display unit 220 of the second terminal 200 and a signal for verifying that the original plaintext to be signed (M) is not changed may be received from the user.

In S309, the security assistant service unit 230 may generate the original verification message for verifying that the original plaintext to be signed (M) is not changed.

In S310, the security assistant service unit 230 may transmit the original verification message to the security assistant service unit 230. In S311, the security assistant host unit 130 may transmit the original verification message to the application unit 110. In S312, the application unit 110 may transmit the original verification message to the secure element unit 120.

In S313, the secure element unit 120 may verify the verification message.

In S314, the secure element unit 120 may perform digital signing (Sign(H)) on a value hashed in the second terminal 200. Alternatively, instead of the digital signing, the original verification and validation information may be generated. A server connected to the application unit 110 which requests the digital signature, for example, a mobile banking server or a mobile transaction certification server, may receive the original verification and validation information in addition to the digital signature value and verify that the original corresponding to the digital signature value is verified by the user and is not fabricated. The original verification and validation information refers to information that can be verified using a key held by the server connected to the application unit.

In S315, the digital signature (Sign(H)) in S314 may be transmitted to the application unit 110.

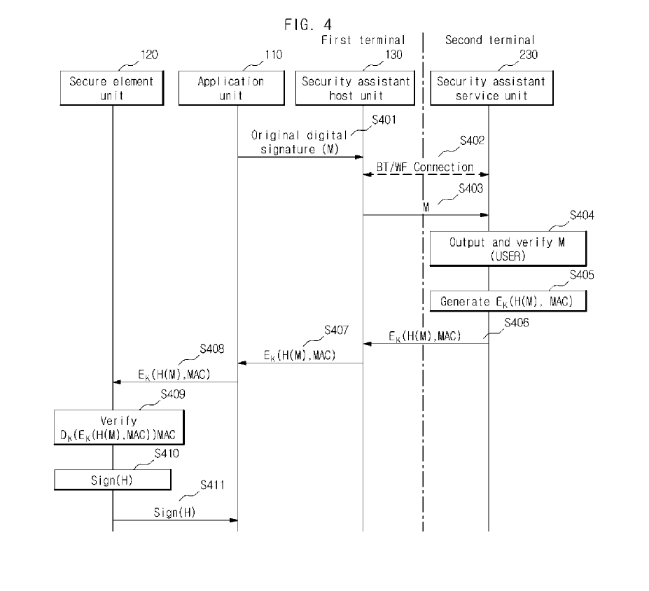

FIG. 4 is a sequence diagram illustrating a method of providing a digital signature assistant service according to an embodiment of the invention.

The method of providing a digital signature assistant service according to the embodiment of the invention may include, generating, by the first terminal 100, the original plaintext to be signed (M) and transmitting the signature to the second terminal 200, displaying the original plaintext to be signed (M) on the second terminal 200, receiving a signal for verifying with the user that the original plaintext to be signed (M) is not changed, generating the original verification message including the original plaintext to be signed (M) or the hash value (H) of the original plaintext to be signed (M), connecting the second terminal 200 to the first terminal 100 via a short-distance communication network, transmitting, by the second terminal 200, the original verification message to the first terminal 100, receiving, by the first terminal 100, the original verification message, verifying the original verification message, decrypting the original plaintext to be signed (M) or the hash value (H) of the original plaintext to be signed (M) included in the original verification message, and digitally signing the decrypted value (D_{K}(E_{K}(H, MAC))).

As illustrated in FIG. 4, in S401, the application unit 110 may transmit the original plaintext to be signed (M) to the security assistant host unit 130.

In S402, the first terminal communication module 140 and the second terminal communication module 240 may be connected.

In S403, the security assistant host unit 130 may transmit the original plaintext to be signed (M) to the security assistant service unit 230.

In S404, the security assistant service unit 230 may display the original plaintext to be signed (M) through the display unit 220 and receive a verification signal from the user through the user interface unit 210.

In S405, an encrypted value (E_{K}(H, MAC)) may be generated by encrypting the hash value (H(M)) of the original plaintext to be signed (M) and a message authentication code (MAC). Here, the message authentication code (MAC) may be included so as to verify, in the secure element unit 120, that a message cryptographically processed and generated in the second terminal is not changed.

In S406 to S408, the encrypted value (E_{K}(H), MAC)) may be transmitted.

In S409, the encrypted value (E_{K}(H, MAC)) is decrypted and the authentication code (MAC) may be verified in the decrypted value (D_{K}(E_{K}(H,MAC))).

In S410, the digital signing value (Sign(H)) of the hash value (H(M)) may be obtained.

In S411, the digital signing value (Sign(H)) may be transmitted to the application unit 110.

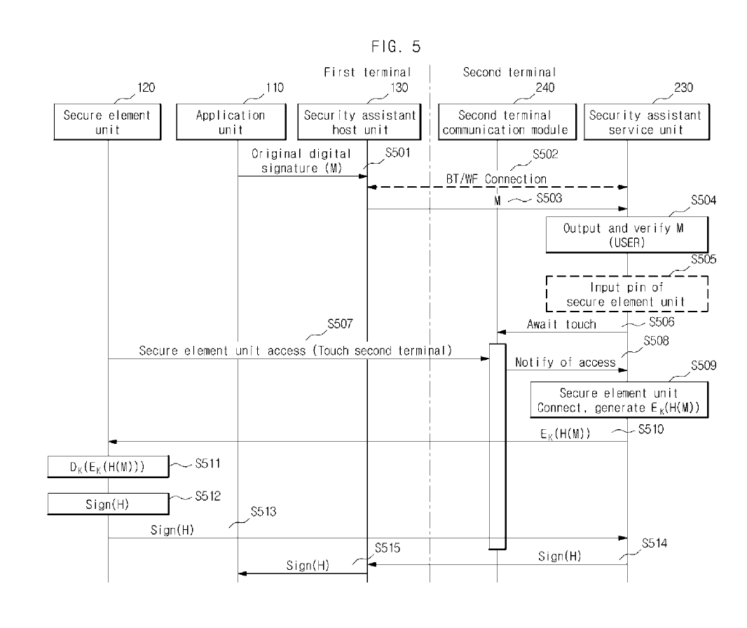

FIG. 5 is a sequence diagram illustrating a method of providing a digital signature assistant service according to an embodiment of the invention.

As illustrated in FIG. 5, in S501, the application unit 110 may transmit the original plaintext to be signed (M) to the security assistant host unit 130.

In S502, the first terminal communication module 140 and the second terminal communication module 240 may be connected. Here, communication may include the short-distance communication.

In S503, the security assistant host unit 130 may transmit the original plaintext to be signed (M) to the security assistant service unit 230.

In S504, the security assistant service unit 230 displays the original plaintext to be signed (M) through the display unit 220 and may receive the verification signal from the user.

In S505, an operation of inputting a password (PIN) of the secure element unit 120 may be further included.

In S506, access of the first terminal 100 through the communication module of the second terminal 200 may be awaited.

In S507, the secure element unit 120 may perform access. In S508, it is possible to provide a notification that the secure element unit 120 has performed access.

In S509, the encrypted value (E_{K}(H(M)) in which the hash value (H(M)) is encrypted may be generated.

In S510, the security assistant service unit 230 may transmit the encrypted value (E_{K}(H(M)) to the secure element unit 120 through the short-distance communication.

In S511, the decrypted value (D_{K}(E_{K}(H(M))) may be generated by decrypting the encrypted value (E_{K}(H(M)).

In S512, the digital signing value (Sign(H)) of the hash value (H(M)) is obtained.

In S513, the digital signing value (Sign(H)) may be transmitted to the security assistant service unit 230.

In S514, the security assistant service unit 230 may transmit the digital signing value (Sign(H)) to the security assistant host unit 130. In S515, the security assistant host unit 130 may transmit the digital signing value (Sign(H)) to the application unit 110.

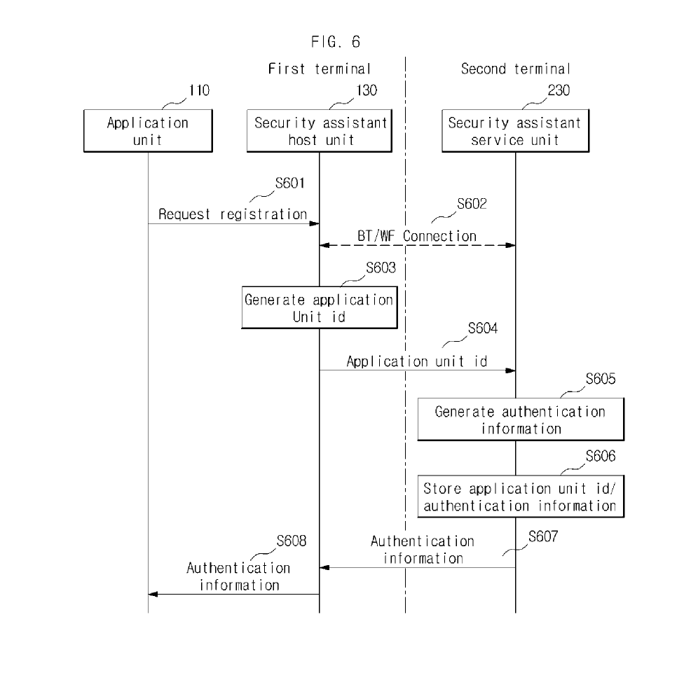

FIG. 6 is a sequence diagram illustrating a method of registering an application according to an embodiment of the invention.

A method of registering an ID of an application according to an embodiment of the invention may include generating and transmitting an ID of the application unit 110 of the first terminal 100, receiving, by the second terminal 200, the ID and generating authentication information of the application unit 110 based on the ID, storing, by the second terminal 200, the authentication information, and transmitting the authentication information to the first terminal 100.

Another embodiment may further include requesting, by the first terminal 100, an inquiry of the authentication information from the second terminal 200, receiving, by the second terminal 200, the request, and making the inquiry of the authentication information, displaying, by the second terminal 200, the authentication information, and receiving the verification signal from the user, and transmitting, by the second terminal 200, an inquiry result including the authentication information to the first terminal 100.

As illustrated in FIG. 6, in S601, the application unit 110 may request registration of the application unit 110 from the security assistant host unit 130.

In S602, the first terminal communication module 140 and the second terminal communication module 240 may be connected.

In S603, the security assistant host unit 130 generates an ID of the application unit 110. In S604, the generated ID of the application unit 110 may be transmitted to the security assistant service unit 230.

In S605, the security assistant service unit 230 generates authentication information based on the ID of the application unit 110. In S606, the authentication information may be stored.

In S607 and S608, the authentication information may be provided to the application unit 110.

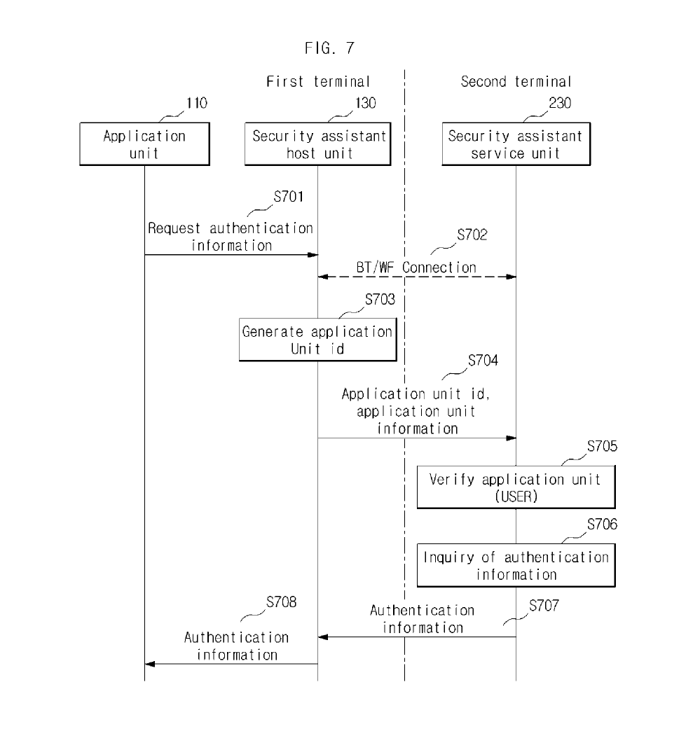

FIG. 7 is a sequence diagram illustrating a method of requesting authentication information of an application according to an embodiment of the invention.

As illustrated in FIG. 7, in S701, the application unit 110 may request the authentication information of the application unit 110 from the security assistant host unit 130.

In S702, the first terminal communication module 140 and the second terminal communication module 240 may be connected.

In S703, the security assistant host unit 130 may generate an ID of the application unit 110 for which the authentication information is requested.

In S704, the security assistant host unit 130 may transmit the ID of the application unit 110 for which the authentication information is requested and information on the application unit 110 for which the authentication information is requested to the security assistant service unit 230.

In S705, the user may verify the ID of the application unit 110 for which the authentication information is requested and the information on the application unit 110 for which the authentication information is requested.

In S706, the ID of the application unit 110 for which the authentication information is requested and the authentication information may be inquired of.

In S707 and S708, the authentication information may be provided to the application unit 110.

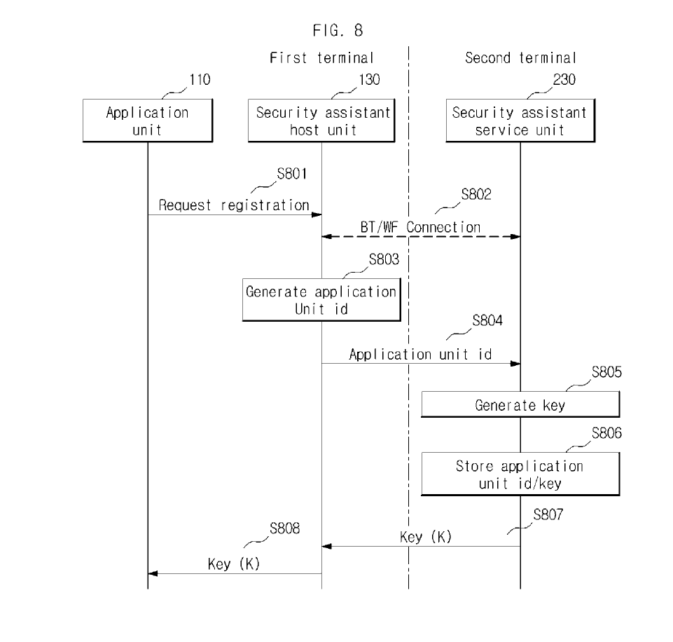

FIG. 8 is a sequence diagram illustrating a method of providing a confidential information service according to an embodiment of the invention.

As illustrated in FIG. 8, in S801, the application unit 110 may request registration of the application unit 110 from the security assistant host unit 130.

In S802, the first terminal communication module 140 and the second terminal communication module 240 may be connected.

In S803, the security assistant host unit 130 may generate the ID of the application unit 110.

In S804, the security assistant host unit 130 may transmit the ID of the application unit 110 to the security assistant service unit 230.

In S805, the security assistant service unit 230 may generate a key based on the ID of the application unit 110.

In S806, the security assistant service unit 230 may store the key and the ID of the application unit 110.

In S807 and S808, the key may be transmitted to the application unit 110.

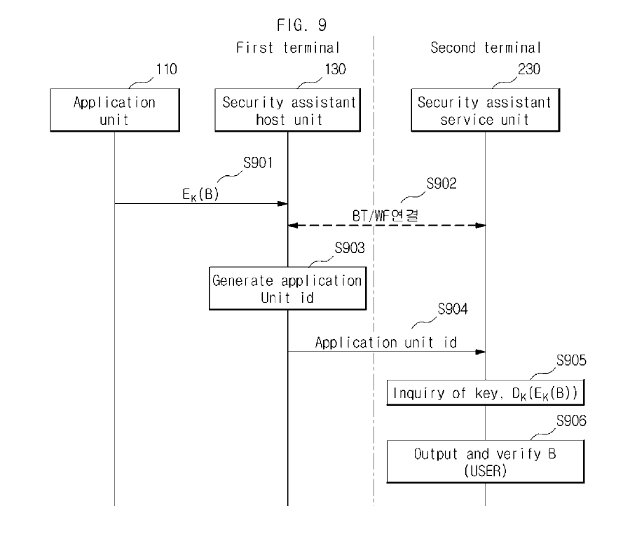

FIG. 9 is a sequence diagram illustrating a method of providing a confidential information service according to an embodiment of the invention.

As illustrated in FIG. 9, in S901, the application unit 110 may transmit an encrypted value (E_{K}(B)) in which confidential information (B) is encrypted using the key received in S808 to the security assistant host unit 130.

In S902, the first terminal communication module 140 and the second terminal communication module 240 may be connected.

In S903, the security assistant host unit 130 may generate the ID of the application unit 110.

In S904, the security assistant host unit 130 may transmit the ID of the application unit 110 to the security assistant service unit 230.

In S905, the security assistant service unit 230 makes an inquiry of the key based on the ID of the application unit 110 and may generate the decrypted value (D_{K}(E_{K}(B))) in which the encrypted value (E_{K}(B)) having the confidential information (B) encrypted therein is decrypted using the key.

In S906, the security assistant service unit 230 may display the confidential information (B) and receive the verification signal from the user.

Methods according to various embodiments of the invention may be implemented in the form of program instructions that can be performed through various computer units and recorded in computer readable media. The computer readable media may include a program instruction, a data file, a data structure, or combinations thereof.

The program instruction recorded in the computer readable media may be specially designed and prepared for the invention or may be an available well-known instruction for those skilled in the field of computer software. Examples of computer readable recording media include, for example, magnetic media such as a hard disk, a floppy disk, and a magnetic tape, optical media such as a CD-ROM and a DVD, magneto-optical media such as a floptical disk, and a hardware device, such as a ROM, a RAM, and a flash memory, that is specially made to store and perform the program instruction. Examples of the program instruction may include a machine code generated by a compiler and a high-level language code that can be executed in a computer using an interpreter.

The above hardware device may be configured as at least one software module in order to perform operations of the invention and vice versa.

In the device and method for providing a security assistant service according to the embodiment of the invention, the second terminal such as a smart watch or smart glasses may enhance a security function of the first terminal such as a smartphone or a tablet.

In addition, in the device and method for providing a security assistant service according to the embodiment of the invention, it is possible to prevent digital signing data from being maliciously changed by the first terminal in advance, prevent the authentication information from being leaked in the first terminal, and check a risk of confidential information leakage in the second terminal in advance.

In addition, in the device and method for providing a security assistant service according to the embodiment of the invention, it is possible to securely use the service even when the second terminal is hacked and it is possible to prevent the terminal from being abused using only information obtained in the second terminal even when the first terminal is hacked.

While the present invention has been particularly described with reference to exemplary embodiments, it will be understood by those skilled in the art that various changes in form and details may be made without departing from the spirit and scope of the present invention. Therefore, the exemplary embodiments should be considered in a descriptive sense only and not for purposes of limitation. The scope of the invention is defined not by the detailed description of the invention but by the appended claims, and encompasses all modifications and equivalents that fall within the scope of the appended claims and will be construed as being included in the present invention.

### REFERENCE NUMERALS

100: first terminal
110: application unit
120: secure element unit
130: security assistant host unit
140: first terminal communication module
200: second terminal
210: user interface unit
220: display unit
230: security assistant service unit
240: second terminal communication module
300: communication network

What is claimed is:

1. A device for providing a security assistant service in which a first terminal and a second terminal are included, the device comprising:
the first terminal configured to generate information for requesting verification of an original plaintext to be signed (here, the information for requesting verification of the original plaintext to be signed refers to the original plaintext to be signed or a hash value of the original plaintext to be signed) and transmit an encrypted value in which the information for requesting verification of the original plaintext to be signed is encrypted and the original plaintext to be signed to the second terminal; and
the second terminal configured to receive the original plaintext to be signed and the encrypted value, decrypt the information for requesting verification of the original plaintext to be signed by decrypting the encrypted value, display the original plaintext to be signed when the original plaintext to be signed or a hash value of the original plaintext to be signed matches the decrypted information for requesting verification of the original plaintext to be signed, receive a verification signal from a user, generate an original verification message (here, the original verification message refers to information indicating that the original plaintext to be signed is verified by the user and the information can be proved using a key held by the second terminal and verified using the key held by the first terminal) and transmit the original verification message to the first terminal.

2. The device of claim 1, wherein a key in which the information for requesting verification of the original plaintext to be signed is encrypted by the first terminal and a key for decrypting the encrypted value by the second terminal are the same key.

3. The device of claim 1, wherein the first terminal is any of a smartphone and a tablet.

4. The device of claim 1, wherein the second terminal is any of a smart watch and smart glasses.

5. The device of claim 1, wherein the first terminal includes:
an application unit configured to generate the information for requesting verification of the original plaintext to be signed;
a secure element unit configured to receive the information for requesting verification of the original plaintext to be signed from the application unit, encrypt and transmit the information for requesting verification of the original plaintext to be signed, receive the original verification message, generate original verification and validation information or a digital signing value for verified request information (here, the original verification and validation information is able to verify that an original corresponding to the digital signature value is verified by the user and is not changed using a key held by a server connected to the application unit when the server connected to the application unit for which a digital signature is requested receives the original verification and validation information in addition to a digital signature value), and provide the information to the application unit;
a security assistant host unit configured to receive the original plaintext to be signed from the application unit, receive the encrypted value from the secure element unit, and request verification of the original plaintext to be signed from the second terminal; and
a first terminal communication module configured to connect the first terminal and the second terminal via a communication network.

6. The device of claim 5, wherein the security assistant host unit receives a registration request of the application unit from the application unit, generates an ID of the application unit, and requests registration of the ID from the second terminal.

7. The device of claim 6, wherein the ID includes at least one of a unique identification number of the application unit and an international mobile equipment identity (IMEI) of the first terminal.

8. The device of claim 6, wherein, after an authentication information request of the application unit is received from the application unit and is transmitted to the second terminal, when the second terminal generates authentication information of the application unit and transmits the information to the first terminal, the security assistant host unit provides the authentication information to the application unit.

9. The device of claim 1, wherein the second terminal includes:
a security assistant service unit configured to receive the original plaintext to be signed and the encrypted value from the first terminal, decrypt the information for requesting verification of the original plaintext to be signed (here, the information for requesting verification of the original plaintext to be signed refers to the original plaintext to be signed or a hash value of the original plaintext to be signed) by decrypting the encrypted value, determine whether the original plaintext to be signed or a hash value of the original plaintext to be signed matches a decrypted value, receive a verification signal from the user, and generate the original verification message (here, the original verification message refers to information indicating that the original plaintext to be signed is verified by the user and the information can be proved using a key held by the second terminal and verified using the key held by the first terminal);
a display unit configured to display the original plaintext to be signed when the original plaintext to be signed or the hash value of the original plaintext to be signed matches the decrypted value;
a user interface unit configured to verify the original plaintext to be signed displayed on the display unit by the user; and
a second terminal communication module configured to connect the first terminal and the second terminal via a communication network.

10. A method of providing a security assistant service, comprising:
generating, by a first terminal, an original plaintext to be signed and a hash value of the original plaintext to be signed;
generating, by the first terminal, an encrypted value by encrypting the original plaintext to be signed or the hash value of the original plaintext to be signed using a key;
receiving, by the second terminal, the encrypted value and the original plaintext to be signed from the first terminal, an generating a decrypted value by decrypting the encrypted value using the key;
determining whether the decrypted value matches the original plaintext to be signed or the hash value of the original plaintext to be signed;
displaying the original plaintext to be signed when the decrypted value matches the original plaintext to be signed or the hash value of the original plaintext to be signed;
receiving a signal for verifying that the original plaintext to be signed is not changed from the user and generating the original verification message; and
transmitting, by the second terminal, the original verification message to the first terminal.

11. The method of claim 10, wherein the first terminal is any of a smartphone and a tablet.

12. The method of claim 10, wherein the second terminal is any of a smart watch and smart glasses.

13. A method of providing a security assistant service, comprising:
generating, by a first terminal, an original plaintext to be signed, and transmitting the signature to a second terminal;
displaying the original plaintext to be signed on the second terminal, receiving a signal for verifying that the original plaintext to be signed is not changed from the user, and generating the original verification message including the original plaintext to be signed or a hash value of the original plaintext to be signed;
connecting the second terminal to the first terminal via a short-distance communication network;
transmitting, by the second terminal, the original verification message to the first terminal;
receiving, by the first terminal, the original verification message, verifying the original verification message, and decrypting the original plaintext to be signed included in the original verification message or the hash value of the original plaintext to be signed; and
digitally signing the decrypted value or generating original verification and validation information (here, the original verification and validation information is able to verify that an original corresponding to the digital signature value is verified by the user and is not changed using a key held by a server connected to the application unit when the server connected to the application unit for which a digital signature is requested receives the original verification and validation information in addition to a digital signature value).

14. A method of providing a security assistant service, comprising:
generating and transmitting an ID of an application unit of a first terminal;
receiving, by a second terminal, the ID, and generating authentication information of the application unit based on the ID; and
storing, by the second terminal, the authentication information, and transmitting the authentication information to the first terminal.

15. The method of claim 14, further comprising:
requesting, by the first terminal, an inquiry of the authentication information from the second terminal;
receiving, by the second terminal, the request, and making an inquiry of the authentication information;
displaying, by the second terminal, the authentication information, and receiving a verification signal from the user; and
transmitting, by the second terminal, an inquiry result including the authentication information to the first terminal.
